(19) United States
(12) Patent Application Publication
(10) Pub. No.: US 2025/0313298 A1
(43) Pub. Date: Oct. 9, 2025

(54) MOTORCYCLE PARTS SUPPORT DEVICE

(71) Applicant: Roy Morey, Casco, MI (US)

(72) Inventor: Roy Morey, Casco, MI (US)

(21) Appl. No.: 18/629,319

(22) Filed: Apr. 8, 2024

(51) Int. Cl. B62K 11/02

(52) U.S. Cl. CPC B62K 11/02

(57) ABSTRACT

A motorcycle parts support device for supporting body panels of a motorcycle includes a frame has a series of interconnecting tubes which are strategically oriented with each other such that the frame resembles a structural frame of a motorcycle. In this way the series of interconnecting tubes can support a pair of saddle bags of a motorcycle, a seat of a motorcycle, a fuel tank of a motorcycle, a pair of side farings of a motorcycle and a storage box of a motorcycle. A front faring mount is attached to the series of interconnecting tubes to support a front faring of the motorcycle. A rear roller unit and a front roller unit is each attached to a respective one of the series of interconnected tubes to roll along a support surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to parts support devices and more particularly pertains to a new parts support device for supporting body panels of a motorcycle while the motorcycle is undergoing maintenance or service thereby inhibiting the body panels from being damaged. The device includes a frame which comprises a series of interconnected tubes which are strategically oriented such the frame resembles the structural frame of a motorcycle. In this way a seat and a fuel tank and a pair of saddle bags and a storage box and a pair of side farings can be mounted to the frame. The device includes a front faring mount which is attached to the frame for supporting a front faring of the motorcycle. The device includes a front roller unit and a rear roller unit each attached to the frame to facilitate the frame to be rolled along a support surface.

### (2) Description of Related Art Including Information Disclosed Under 37 CFR 1.97 and 1.98

The prior art relates to parts support devices including a variety of motorcycle structural frames and a variety of body panel support rack devices for supporting body panels of a vehicle to facilitate the body panels to be painted and which each includes rollers for rolling along a support surface. In no instance does the prior art disclose a motorcycle support frame device that comprises a series of interconnected tubes that are strategically oriented to resemble the structural frame of a motorcycle thereby facilitating body panels of a motorcycle to be mounted to the series of interconnected tubes and a front faring mount attached to the series of interconnected tubes for supporting a front faring of the motorcycle when the motorcycle is being maintained or serviced thereby inhibiting the body panels and the front faring from being damaged.

### BRIEF SUMMARY OF THE INVENTION

An embodiment of the disclosure meets the needs presented above by generally comprising a frame has a series of interconnecting tubes which are strategically oriented with each other such that the frame resembles a structural frame of a motorcycle. In this way the series of interconnecting tubes can support a pair of saddle bags of a motorcycle, a seat of a motorcycle, a fuel tank of a motorcycle, a pair of side farings of a motorcycle and a storage box of a motorcycle. A front faring mount is attached to the series of interconnecting tubes to support a front faring of the motorcycle. A rear roller unit and a front roller unit is each attached to a respective one of the series of interconnected tubes to roll along a support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a right side view of a motorcycle parts support device according to an embodiment of the disclosure.

FIG. 2 is a top view of an embodiment of the disclosure.

FIG. 3 is a front view of an embodiment of the disclosure.

FIG. 4 is a right side in-use view of an embodiment of the disclosure.

FIG. 5 is a perspective in-use view of an embodiment of the disclosure.

### DETAILED DESCRIPTION OF THE INVENTION

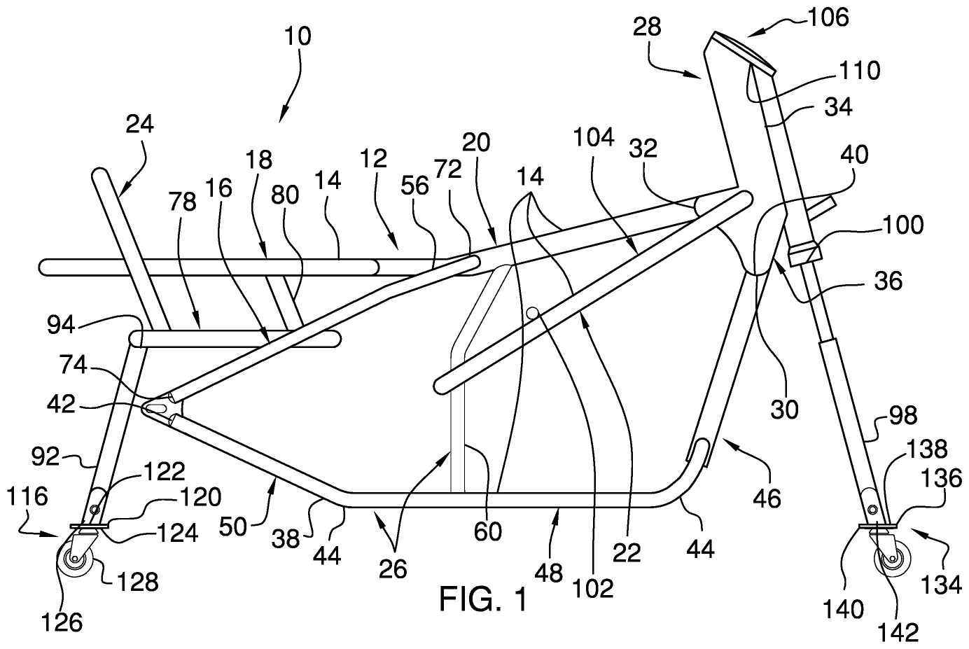

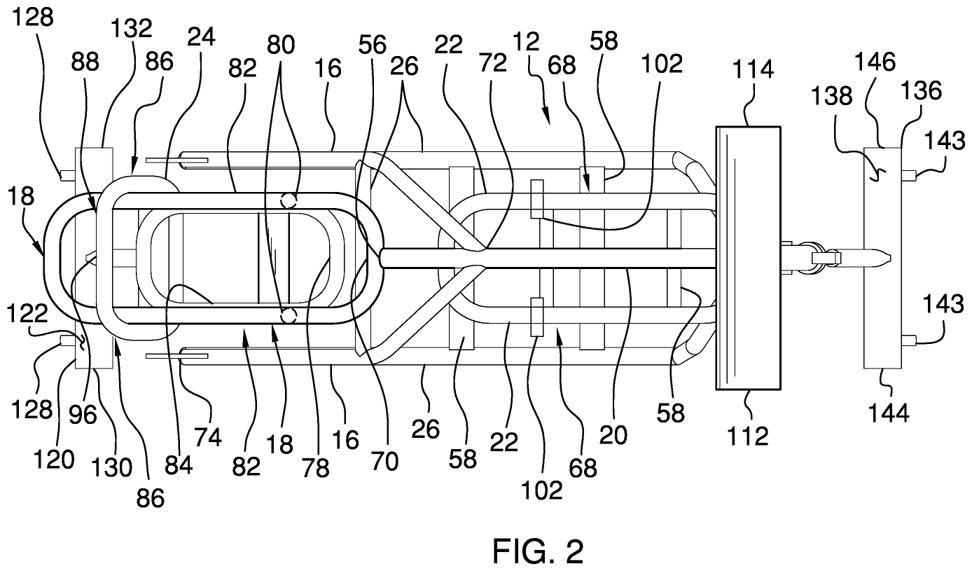

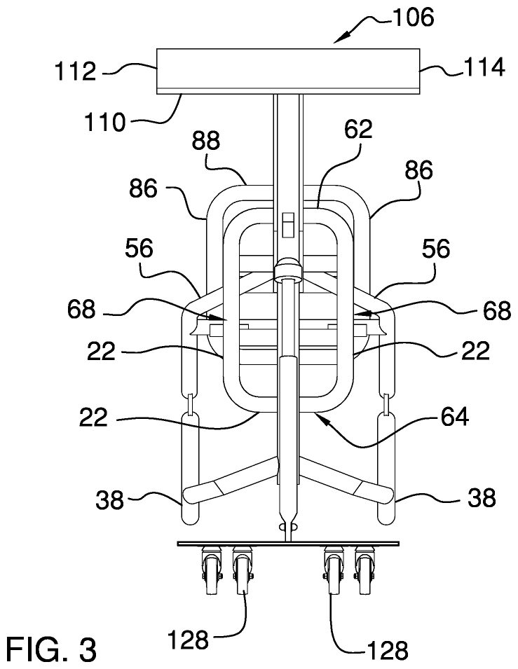

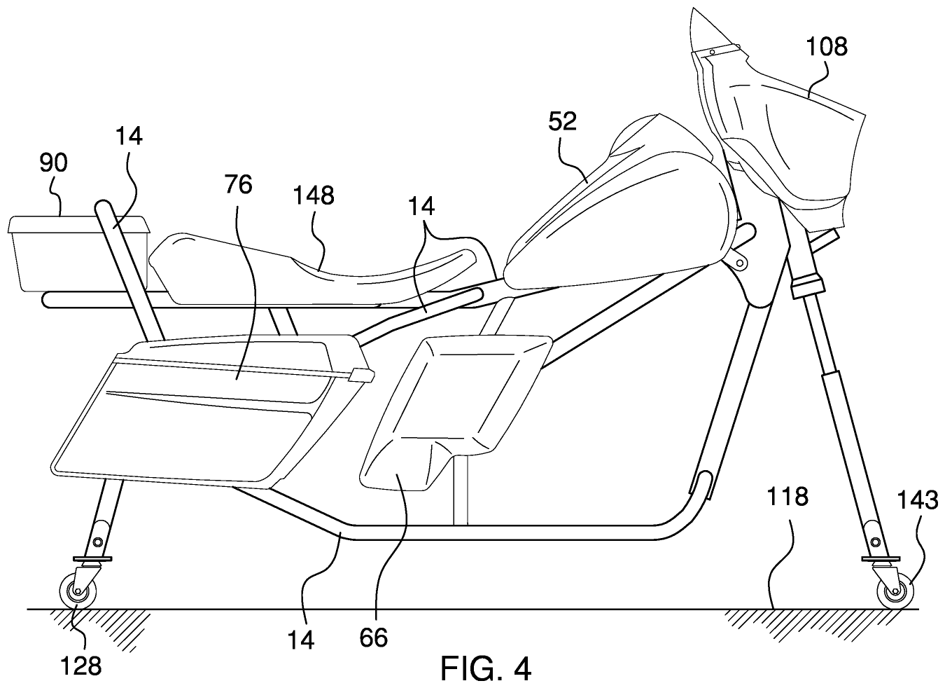

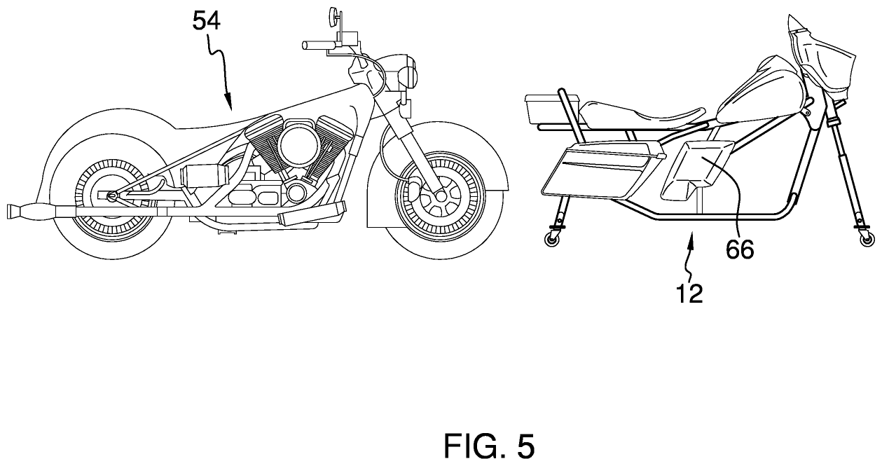

With reference now to the drawings, and in particular to FIGS. 1 through 5 thereof, a new parts support device embodying the principles and concepts of an embodiment of the disclosure and generally designated by the reference numeral 10 will be described.

As best illustrated in FIGS. 1 through 5, the motorcycle parts support device 10 generally comprises a frame 12 which has a series of interconnecting tubes 14 that are strategically oriented with each other such that the frame 12 resembles a structural frame of a motorcycle. The series of interconnecting tubes 14 includes a set of saddle bag tubes 16 and a set of seat tubes 18 and a fuel tank tube 20 and a set of side faring tubes 22 and a set of storage box tubes 24 and a set of structural support tubes 26. Additionally, the frame 12 includes a fork support 28 which has a first lobe 30 and a second lobe 32 and a tower 34. Each of the first lobe 30 and the second lobe 32 is located adjacent to a bottom end 36 of the tower 34 and each of the first lobe 30 and the second lobe 32 extends rearwardly from the tower 34.

The set of structural support tubes 26 includes a pair of lower tubes 38 which each has a front end 40 and a rear end 42. Additionally, each of the pair of lower tubes 38 has a series of bends 44 being distributed between the front end 40 and the rear end 42 which define a forward portion 46 angling forwardly from a lower portion 48 and a rearward portion 50 angling rearwardly from the lower portion 48. The forward portion 46 is associated with the front end 40 and the rearward portion 50 is associated with the rear end 42. The front end 40 of each of the pair of lower tubes 38 is coupled to the first lobe 30 of the fork support 28 such that the lower portion 48 of each of the pair of lower tubes 38 is horizontally oriented. Furthermore, each of the pair of lower tubes 38 is oriented to angle outwardly from the first lobe 30 in opposite direction from each other.

The fuel tank tube 20 is coupled to the second lobe 32 of the fork support 28 having the fuel tank tube 20 being oriented at a downward angle such that the fuel tank tube 20 can support a fuel tank 52 of a motorcycle 54. In this way the fuel tank 52 can be removed from the motorcycle 54 on which it is attached when the motorcycle 54 is undergoing service or maintenance thereby inhibiting the fuel tank 52 from being scratched or damaged. The motorcycle 54 may be a touring motorcycle of any manufacturer or design that typically involves custom paint schemes that are applied to various body panels of the motorcycle 54.

The set of structural support tubes 26 includes a plurality of horizontally oriented tubes 58 which each extend between the lower portion 48 of each of the pair of lower tubes 38. The plurality of horizontally oriented tubes 58 are spaced apart from each other and are distributed along the lower portion 48 of each of the pair of lower tubes 38. The set of structural support tubes 26 includes a central tube 60 that is coupled between the fuel tank tube 20 and a respective one of the plurality of horizontally oriented tubes 58. The set of side faring tubes 22 is perpendicularly oriented with each other such that the set of side faring tubes 22 defines a rectangle. A frontmost one of the set of side faring tubes 62 is coupled to the second lobe 32 of the fork support 28 tubes and a rearmost one of the set of side faring tubes 64 is coupled to the central tube 60 having the set of side faring tubes 22 angling downwardly between the second lobe 32 and the central tube 60. In this way a respective one of a pair of side farings 66 of the motorcycle 54 can mounted to a respective outward tube 68 of the set of side faring tubes 22 when the motorcycle 54 is being serviced or maintained.

The set of seat tubes 18 is perpendicularly oriented with each other such that the set of seat tubes 18 defines a rectangle and a frontmost one of the set of seat tubes 70 is coupled to a rear end 56 of the fuel tank tube 20 such that the set of seat tubes 18 lies on a horizontal plane. Each of the set of saddle bag tubes 16 has a first end 72 that is coupled to the fuel tank tube 20 and a second end 74 that is coupled to rear end 42 of a respective one of the pair of lower tubes 38. In this way a respective one of a pair of saddle bags 76 of the motorcycle 54 can be mounted to a respective saddle bag tube when the motorcycle 54 is being maintained or serviced. Thus, the saddle bags 76 are inhibited from being scratched or damaged while the motorcycle 54 is being maintained or serviced. Additionally, each of the set of saddle bag tubes 16 is oriented to angle downwardly between the fuel tank tube 20 and the respective lower tube.

The set of structural support tubes 26 including a set of rear tubes 78 which are perpendicularly oriented with each other such that the set of rear tubes 78 defines a rectangle. The set of structural support tubes 26 includes a pair of vertical tubes 80 each coupled between a respective one of a pair of sidelong tubes 82 of the set of seat tubes 18 and a respective one of a pair of sidelong tubes 84 of the set of rear tubes 78. Furthermore, the set of rear tubes 78 is positioned beneath the set of seat tubes 18 having the set of rear tubes 78 lying on a horizontal plane. The set of storage box tubes 24 is perpendicularly oriented with each other such that the set of storage box tubes 24 defines a rectangle.

Each of a pair of sidelong tubes 86 of the set of storage box tubes 24 is coupled to and angles upwardly and rearwardly from a respective one of the pair of sidelong tubes 84 of the set of rear tubes 78 such that a topmost one 88 of the set of storage box tubes 24 is positioned above the set of seat tubes 18. In this way a storage box 90 of the motorcycle 54 can be positioned on top of the set of seat tubes 18 such that the set of storage box tubes 24 surrounds the storage box 90. Thus, the storage box 90 is inhibited from being damaged or scratched while the motorcycle 54 is being maintained or serviced The set of structural support tubes 26 includes a rear roller tube 92 that has an upper end 94 which is coupled to a rearmost one 96 of the set of rear tubes 78 having the rear roller tube 92 angling rearwardly and downwardly from the rearmost rear tube 96. Additionally, the set of structural support tubes 26 includes a front roller tube 98 that has an upper end 100 which is coupled to the fork support 28 having the front roller tube 98 angling forwardly and downwardly from the fork support 28.

A pair of grommets 102 is each attached to a respective one of the set of side faring tubes 22 and each of the pair of grommets 102 can be engaged by a respective one of the pair of side farings 66 of the motorcycle 54 for retaining the respective side faring 66 on a respective side faring tube 22. In this way the pair of side farings 66 is inhibited from being damaged or scratched while the motorcycle 54 is being maintained or serviced. Each of the pair of grommets 102 is positioned on a top side 104 of a respective one of the outward tubes 68 of the set of side faring tubes 22. Furthermore, each of the pair of grommets 102 may be comprised of a resiliently compressible material, such as rubber or silicone for example, which can receive mounting pegs on the respective side faring.

A front faring mount 106 is attached to the series of interconnecting tubes 14 such that a front faring 108 of the motorcycle 54 can be mounted to the front faring mount 106. The front faring mount 106 has a lower surface 110 and a first lateral edge 112 and a second lateral edge 114; the front faring 108 mount 106 is elongated between the first lateral edge 112 and the second lateral edge 114. Additionally, the lower surface 110 is attached to the tower 34 of the fork support 28 at a point that is centrally located between the first lateral edge 112 and the second lateral edge 114.

A rear roller unit 116 is attached to a respective one of the series of interconnected tubes 14 such that the rear roller unit 116 can roll along a support surface 118 thereby supporting the frame 12 above the support surface 118. The support surface 118 may be a floor of a service shop or other type of horizontal support surface upon which the motorcycle is situated. The rear roller unit 116 comprises a rear panel 120 that has an upper surface 122 and a lower surface 124. The upper surface 124 is coupled to a lower end 126 of the rear roller tube 92 at a point that is centrally located on the upper surface 122. The rear roller unit 116 includes a pair of rear rollers 128 that is each rotatably attached to the lower surface 124 of the rear panel 120 to roll along the support surface 118. Additionally, each of the pair of rear rollers 128 is positioned adjacent a respective one of a first lateral edge 130 and a second lateral edge 132 of the rear panel 120. Each of the pair of rear rollers 128 may comprise casters or wheels or any other type of roller which can roll along a horizontal plane.

A front roller unit 134 is attached to a respective one of the series of interconnected tubes 14 such that the front roller unit 134 can roll along the support surface 118 thereby supporting the frame 12 above the support surface 118. The front roller unit 134 comprises a front panel 136 that has an upper surface 138 and a lower surface 140. The upper surface 138 of the front panel 136 is coupled to a lower end 142 of the front roller tube 98 at a point which is centrally located on the upper surface 138 of the front panel 136. A pair of front rollers 143 is provided and each of the pair of front rollers 143 is rotatably attached to the lower surface 140 of the front panel 136 to roll along the support surface 118. Each of the pair of front rollers 143 is positioned adjacent a respective one of a first lateral edge 144 and a second lateral edge 146 of the front panel 136. Each of the front rollers 143 may comprise casters or wheels or other type of roller that can roll along a horizontal plane.

In use, the fuel tank 52 and the front faring 108 and the pair of side farings 66 and the storage box 90 and a seat 148 of the motorcycle 54 and the pair of saddle bags 76 are removed from the motorcycle 54 when the motorcycle 54 is scheduled to undergo maintenance or service. Furthermore, the fuel tank 52 is placed on the fuel tank tube 20 and the front faring 108 is placed on the front faring mount 106 and the pair of side farings 66 are mounted to the respective grommet 102 and the storage box 90 is placed on the storage box tubes 24 and the seat 148 is placed on the seat tubes 18 and the saddle bags 76 are placed on the saddle bag tubes 16. In this way each of the fuel tank 52 and the front faring 108 and the pair of side farings 66 and the storage box 90 and the seat 148 and the saddle bags 76 are protected from being scratched or damaged while the motorcycle 54 is being maintained or serviced. Damage to the paint or other structural damage to the various body panels of motorcycles is a common occurrence during maintenance or service being performed on motorcycles. The frame 12 ensures that the appearance of the various body panels of the motorcycle 54 is preserved while the motorcycle 54 is being maintained or serviced by facilitating the fuel tank 52 and the front faring 108 and the side farings 66 and the storage box 90 and the seat 148 and the saddle bags 76 to be safely stored away from the motorcycle 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorcycle parts support device for storing body panels of a motorcycle while the motorcycle is being serviced thereby inhibiting the body panels from being damaged, said device comprising:
a frame having a series of interconnecting tubes being strategically oriented with each other such that said frame resembles a structural frame of a motorcycle, said series of interconnecting tubes including a set of saddle bag tubes wherein said set of saddle bag tubes is configured to support a pair of saddle bags of a motorcycle, said series of interconnecting tubes including a set of seat tubes wherein said set of seat tubes is configured to support a seat of a motorcycle, said series of interconnecting tubes including a fuel tank tube wherein said fuel tank tube is configured to support a fuel tank of a motorcycle, said series of interconnecting tubes including a set of side faring tubes wherein said set of side faring tubes is configured to support a pair of side farings of a motorcycle, said series of interconnecting tubes including a set of storage box tubes wherein said set of storage box tubes is configured to support a storage box of a motorcycle, said series of interconnecting tubes including a set of structural support tubes;
a pair of grommets, each of said pair of grommets being attached to a respective one of said set of side faring tubes wherein each of said pair of grommets is configured to be engaged by a respective one of the pair of side farings for retaining the respective side faring on a respective side faring tube;
a front faring mount being attached to said series of interconnecting tubes wherein said front faring mount is configured to have a front faring mounted to said front faring mount;
a rear roller unit being attached to a respective one of said series of interconnected tubes wherein said rear roller unit is configured to roll along a support surface thereby supporting said frame above the support surface; and
a front roller unit being attached to a respective one of said series of interconnected tubes wherein said front roller unit is configured to roll along the support surface thereby supporting said frame above the support surface.

2. The assembly according to claim 1, wherein:
said frame includes a fork support having a first lobe and a second lobe and a tower;
each of said first lobe and said second lobe is located adjacent to a bottom end of said tower having each of said first lobe and said second lobe extending rearwardly from said tower;
said set of structural support tubes includes a pair of lower tubes each having a front end and a rear end;
each of said pair of lower tubes has a series of bends being distributed between said front end and said rear end defining a forward portion angling forwardly from a lower portion and a rearward portion angling rearwardly from said lower portion;
said forward portion is associated with said front end;
said rearward portion is associated with said rear end;
said front end of each of said pair of lower tubes is coupled to said first lobe of said fork support such that said lower portion of each of said pair of lower tubes is horizontally oriented; and
each of said pair of lower tubes is oriented to angle outwardly from said first lobe in opposite direction from each other.

3. The assembly according to claim 2, wherein said fuel tank tube is coupled to said second lobe of said fork support having said fuel tank tube being oriented at a downward angle wherein said fuel tank tube is configured to support a fuel tank of a motorcycle.

4. The assembly according to claim 2, wherein:
said set of structural support tubes includes a plurality of horizontally oriented tubes which each extend between said lower portion of each of said pair of lower tubes;
said plurality of horizontally oriented tubes is spaced apart from each other and is distributed along said lower portion of each of said pair of lower tubes; and
said set of structural support tubes includes a central tube being coupled between said fuel tank tube and a respective one of said plurality of horizontally oriented tubes.

5. The assembly according to claim 2, wherein:
said set of structural support tubes includes a central tube;
said set of side faring tubes is perpendicularly oriented with each other such that said set of side faring tubes defines a rectangle;
a frontmost one of said set of side faring tubes is coupled to said second lobe of said fork support tubes; and
a rearmost one of said set of side faring tubes is coupled to said central tube having said set of side faring tubes angling downwardly between said second lobe and said central tube wherein each of a pair of outward tubes of said set of side faring tubes is configured to have a respective one of a pair of side farings being mounted to a respective outward tube of said set of side faring tubes.

6. The assembly according to claim 2, wherein:
each of said set of saddle bag tubes has a first end being coupled to said fuel tank tube and a second end being coupled to rear end of a respective one of said pair of lower tubes wherein each of said pair of saddle bag tubes is configured to have a respective one of a pair of saddle bags being mounted to a respective saddle bag tube; and
each of said set of saddle bag tubes is oriented to angle downwardly between said fuel tank tube and said respective lower tube.

7. The assembly according to claim 1, wherein:
said set of seat tubes is perpendicularly oriented with each other such that said set of seat tubes defines a rectangle; and
a frontmost one of said set of seat tubes is coupled to a rear end of said fuel tank tube having said set of seat tubes lying on a horizontal plane;
said set of structural support tubes includes a set of rear tubes being perpendicularly oriented with each other such that said set of rear tubes defines a rectangle; and
said set of structural support tubes includes a pair of vertical tubes each being coupled between a respective one of a pair of sidelong tubes of said set of seat tubes and a respective one of a pair of sidelong tubes of said set of rear tubes such that said set of rear tubes is positioned beneath said set of seat tubes having said set of rear tubes lying on a horizontal plane.

8. The assembly according to claim 7, wherein:
said set of storage box tubes is perpendicularly oriented with each other such that said set of storage box tubes defines a rectangle; and
each of a pair of sidelong tubes of said set of storage box tubes is coupled to and angles upwardly and rearwardly from a respective one of said pair of sidelong tubes of said set of rear tubes such that a topmost one of said set of storage box tubes is positioned above said set of seat tubes wherein said set of seat tubes is configured to have a storage box positioned on top of said set of seat tubes such that said set of storage box tubes surrounds the storage box.

9. The assembly according to claim 7, wherein:
said set of structural support tubes includes a rear roller tube having an upper end being coupled to a rearmost one of said set of rear tubes having said rear roller tube angling rearwardly and downwardly from said rearmost rear tube; and
said rear roller unit comprises:
a rear panel having an upper surface and a lower surface, said upper surface being coupled to a lower end of said rear roller tube at a point being centrally located on said upper surface; and
a pair of rear rollers, each of said pair of rear rollers being rotatably attached to said lower surface of said rear panel wherein each of said pair of rear rollers is configured to roll along the support surface, each of said pair of rear rollers being positioned adjacent a respective one of a first lateral edge and a second lateral edge of said rear panel.

10. The assembly according to claim 2, wherein:
said set of structural support tubes includes a front roller tube having an upper end being coupled to said fork support having said front roller tube angling forwardly and downwardly from said fork support; and
said front roller unit comprises:
a front panel having an upper surface and a lower surface, said upper surface of said front panel being coupled to a lower end of said front roller tube at a point being centrally located on said upper surface of said front panel; and
a pair of front rollers, each of said pair of front rollers being rotatably attached to said lower surface of said front panel wherein each of said pair of front rollers is configured to roll along the support surface, each of said pair of front rollers being positioned adjacent a respective one of a first lateral edge and a second lateral edge of said front panel.

11. The assembly according to claim 1, wherein:
said frame includes a fork support having a first lobe and a second lobe and a tower;
said front faring mount has a lower surface and a first lateral edge and a second lateral edge;
said front faring mount is elongated between said first lateral edge and said second lateral edge; and
said lower surface is attached to said tower of said fork support at a point being centrally located between said first lateral edge and said second lateral edge.

12. A motorcycle parts support device for storing body panels of a motorcycle while the motorcycle is being serviced thereby inhibiting the body panels from being damaged, said device comprising:
a frame having a series of interconnecting tubes being strategically oriented with each other such that said frame resembles a structural frame of a motorcycle, said series of interconnecting tubes including a set of saddle bag tubes and a set of seat tubes and a fuel tank tube and a set of side faring tubes and a set of storage box tubes and a set of structural support tubes, said frame including a fork support having a first lobe and a second lobe and a tower, each of said first lobe and said second lobe being located adjacent to a bottom end of said tower having each of said first lobe and said second lobe extending rearwardly from said tower, said set of structural support tubes including a pair of lower tubes each having a front end and a rear end, each of said pair of lower tubes having a series of bends being distributed between said front end and said rear end defining a forward portion angling forwardly from a lower portion and a rearward portion angling rearwardly from said lower portion, said forward portion being associated with said front end, said rearward portion being associated with said rear end, said front end of each of said pair of lower tubes being coupled to said first lobe of said fork support such that said lower portion of each of said pair of lower tubes is horizontally oriented, each of said pair of lower tubes being oriented to angle outwardly from said first lobe in opposite direction from each other, said fuel tank tube being coupled to said second lobe of said fork support having said fuel tank tube being oriented at a downward angle wherein said fuel tank tube is configured to support a fuel tank of a motorcycle, said set of structural support tubes including a plurality of horizontally oriented tubes which each extend between said lower portion of each of said pair of lower tubes, said plurality of horizontally oriented tubes being spaced apart from each other and being distributed along said lower portion of each of said pair of lower tubes, said set of structural support tubes including a central tube being coupled between said fuel tank tube and a respective one of said plurality of horizontally oriented tubes, said set of side faring tubes being perpendicularly oriented with each other such that said set of side faring tubes defines a rectangle, a frontmost one of said set of side faring tubes being coupled to said second lobe of said fork support tubes, a rearmost one of said set of side faring tubes being coupled to said central tube having said set of side faring tubes angling downwardly between said second lobe and said central tube wherein each of a pair of outward tubes of said set of side faring tubes is configured to have a respective one of a pair of side farings being mounted to a respective outward tube of said set of side faring tubes, said set of seat tubes being perpendicularly oriented with each other such that said set of seat tubes defines a rectangle, a frontmost one of said set of seat tubes being coupled to a rear end of said fuel tank tube having said set of seat tubes lying on a horizontal plane, each of said set of saddle bag tubes having a first end being coupled to said fuel tank tube and a second end being coupled to rear end of a respective one of said pair of lower tubes wherein each of said pair of saddle bag tubes is configured to have a respective one of a pair of saddle bags being mounted to a respective saddle bag tube, each of said set of saddle bag tubes being oriented to angle downwardly between said fuel tank tube and said respective lower tube, said set of structural support tubes including a set of rear tubes being perpendicularly oriented with each other such that said set of rear tubes defines a rectangle, said set of structural support tubes including a pair of vertical tubes each being coupled between a respective one of a pair of sidelong tubes of said set of seat tubes and a respective one of a pair of sidelong tubes of said set of rear tubes such that said set of rear tubes is positioned beneath said set of seat tubes having said set of rear tubes lying on a horizontal plane, said set of storage box tubes being perpendicularly oriented with each other such that said set of storage box tubes defines a rectangle, each of a pair of sidelong tubes of said set of storage box tubes being coupled to and angling upwardly and rearwardly from a respective one of said pair of sidelong tubes of said set of rear tubes such that a topmost one of said set of storage box tubes is positioned above said set of seat tubes wherein said set of seat tubes is configured to have a storage box positioned on top of said set of seat tubes such that said set of storage box tubes surrounds the storage box, said set of structural support tubes including a rear roller tube having an upper end being coupled to a rearmost one of said set of rear tubes having said rear roller tube angling rearwardly and downwardly from said rearmost rear tube, said set of structural support tubes including a front roller tube having an upper end being coupled to said fork support having said front roller tube angling forwardly and downwardly from said fork support;
a pair of grommets, each of said pair of grommets being attached to a respective one of said set of side faring tubes wherein each of said pair of grommets is configured to be engaged by a respective one of the pair of side farings for retaining the respective side faring on a respective side faring tube, each of said pair of grommets being positioned on a top side of a respective one of said outward tubes of said set of side faring tubes;
a front faring mount being attached to said series of interconnecting tubes wherein said front faring mount is configured to have a front faring mounted to said front faring mount, said front faring mount having a lower surface and a first lateral edge and a second lateral edge, said front faring mount being elongated between said first lateral edge and said second lateral edge, said lower surface being attached to said tower of said fork support at a point being centrally located between said first lateral edge and said second lateral edge;
a rear roller unit being attached to a respective one of said series of interconnected tubes wherein said rear roller unit is configured to roll along a support surface thereby supporting said frame above the support surface, said rear roller unit comprising:
a rear panel having an upper surface and a lower surface, said upper surface being coupled to a lower end of said rear roller tube at a point being centrally located on said upper surface; and
a pair of rear rollers, each of said pair of rear rollers being rotatably attached to said lower surface of said rear panel wherein each of said pair of rear rollers is configured to roll along the support surface, each of said pair of rear rollers being positioned adjacent a respective one of a first lateral edge and a second lateral edge of said rear panel; and
a front roller unit being attached to a respective one of said series of interconnected tubes wherein said front roller unit is configured to roll along the support surface thereby supporting said frame above the support surface, said front roller unit comprising:
a front panel having an upper surface and a lower surface, said upper surface of said front panel being coupled to a lower end of said front roller tube at a point being centrally located on said upper surface of said front panel; and
a pair of front rollers, each of said pair of front rollers being rotatably attached to said lower surface of said front panel wherein each of said pair of front rollers is configured to roll along the support surface, each of said pair of front rollers being positioned adjacent a respective one of a first lateral edge and a second lateral edge of said front panel.
